(19) United States
(12) Patent Application Publication
(10) Pub. No.: US 2020/0056900 A1
(43) Pub. Date: Feb. 20, 2020

(54) SURVEILLANCE ROUTE MANAGEMENT FOR A DEVICE

(71) Applicant: Xinova, LLC, Seattle, WA (US)

(72) Inventor: Hyoung-Gon LEE, Seorak-myeon (KR)

(73) Assignee: Xinova, LLC, Seattle, WA (US)

(21) Appl. No.: 16/345,771

(22) PCT Filed: Nov. 28, 2016
(86) PCT No.: PCT/US16/63864

§ 371 Date: Apr. 29, 2019

(51) Int. Cl. G01C 21/34; G01C 21/36

(52) U.S. Cl. CPC G01C 21/3453; G01C 21/3667

(57) ABSTRACT

Technologies are generally described that relate to managing and/or generating a travel route for an electronic device. Some example methods may include generating travel routes for the device with respect to a defined geographic area based on a total travel time for the device to traverse the defined geographic area, selecting a first travel route from the travel routes, and employing the first travel route for the device in response to a determination that the first travel route satisfies a defined security criterion related to an estimated time difference between a first time for the device to reach a location along the first travel route and a second time for the device to reach the location along a second travel route previously employed by the device.

### TECHNICAL FIELD

The subject disclosure relates generally to management of a travel route for a device.

### BACKGROUND

A surveillance system can employ a camera to capture video information associated with a location. The surveillance system can also monitor the location based on the video information captured by the camera. For example, the video information can be viewed and/or analyzed to monitor activity at the location. In certain instances, the camera of the surveillance system can be attached to a human patroller or a drone device (e.g., a quadcopter) to facilitate capturing of the video information. Therefore, the video information can be obtained from the camera while the human patroller or the drone device patrols along a designated patrol route (e.g., a designated patrol route at the location) during a certain interval of patrol.

However, with conventional surveillance systems, an entity can avoid monitoring (i.e., being monitored) and/or surveillance performed by the human patroller or the drone device (e.g., the camera attached to the human patroller or the drone device) by identifying and/or avoiding the designated patrol route and/or the certain interval of patrol. For instance, in an example where an entity identifies and/or avoids a patrol route that connects locations A-B-C-D-E-F through observation by the entity, a time a human patroller or drone device arrives at location F can be determined by the entity if the entity identifies the time that the human patroller or the drone device appears at location A (or location B, etc.). Therefore, an entity in a conventional surveillance system that monitors a particular location can traverse the particular location without being monitored. Furthermore, with a conventional surveillance system that monitors a particular location, relevant video information for an entity that traverses the particular location can be difficult to obtain and/or can be failed to be captured.

The above-described background relating to a surveillance system is merely intended to provide a contextual overview of some current issues, and is not intended to be exhaustive. Other contextual information may become further apparent upon review of the following detailed description.

### SUMMARY

In various, non-limiting embodiments, systems, devices, methods and/or computer-readable storage media that manage and/or generate a travel route for a device are described herein.

In some embodiments, a method may include generating travel routes for the device with respect to a defined geographic area based on a total travel time for the device to traverse the defined geographic area, selecting a first travel route from the travel routes, and employing the first travel route for the device in response to a determination that the first travel route satisfies a defined security criterion related to an estimated time difference between a first time for the device to reach a location along the first travel route and a second time for the device to reach the location along a second travel route previously employed by the device.

In another embodiment, a system includes a route generation component, a route selection component and a route analysis component. The route generation component is configured to generate a set of travel routes with respect to a defined geographic area based on a first defined criterion associated with a total travel time for an electronic device to travel through the defined geographic area. The route selection component is configured to select a first travel route from the set of travel routes. The route analysis component configured to provide the first travel route to the electronic device in response to a determination that the first travel route satisfies a second defined criterion associated with a first estimated time difference between a first time for the electronic device to reach a location along the first travel route and a second time for the electronic device to reach the location along a second travel route previously provided to the electronic device.

In yet another embodiment, a computer-readable storage device stores executable instructions that, in response to execution, cause a device including a processor to perform operations. The operations include: generating travel routes for a device with respect to a geographic area based on a first criterion associated with a first time interval for the device to traverse the geographic area, selecting a first travel route for the device from the travel routes, and utilizing the first travel route for the device in response to a determination that the first travel route satisfies a second criterion associated with a time difference between a first time for the device to reach a location along the first travel route and a second time for the device to reach the location along a second travel route previously utilized by the device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, various non-limiting embodiments are further described with reference to the accompanying drawings in which:

FIG. 1 illustrates an example, non-limiting embodiment of a method to manage and/or generate a travel route for a device with respect to a geographic area;

FIG. 2 illustrates an example, non-limiting embodiment of a system to manage and/or generate a travel route for a device;

FIG. 3 illustrates an example, non-limiting embodiment of another system to manage and/or generate a travel route for a device;

FIG. 4 illustrates an example, non-limiting embodiment of yet another system to manage and/or generate a travel route for a device;

FIG. 5A illustrates an example, non-limiting embodiment of a system associated with a geographic area and a device;

FIG. 5B illustrates another example, non-limiting embodiment of a system associated with a geographic area and a device;

FIG. 6 illustrates an example, non-limiting embodiment of a user interface associated with a device;

FIGS. 7-9 illustrate example, non-limiting embodiments of methods to manage and/or generate a travel route for a device;

FIG. 10 illustrates a flow diagram of an example, non-limiting embodiment of a set of operations to manage and/or generate a travel route for a device; and

FIG. 11 illustrates an example block diagram of a computing device that is arranged to manage and/or generate a travel route for a device in accordance with one or more embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, may be arranged, substituted, combined, separated, and designed in a wide variety of different configurations, all of which are explicitly contemplated herein.

To address issues mentioned above with respect to conventional surveillance systems and/or other issues, one or more embodiments of the present disclosure provide management and/or generation of a travel route for a device with respect to a geographic area. The travel route can be, for example, a mobile surveillance camera route for the geographic area. In one example, the travel route can be randomized (e.g., the travel route or portions of the travel route can be randomized). In an aspect, a set of candidate travel routes can be generated. The set of candidate travel routes can satisfy a criterion associated with a total travel time for the device to traverse a particular candidate travel route associated with the geographic area. Additionally, a candidate travel route can be selected from the set of candidate travel routes. For example, the candidate travel route can be randomly selected from the set of candidate travel routes. The candidate travel route can be employed by the device in response to a determination that the candidate travel route satisfies one or more security conditions. For example, the candidate travel route can be employed by the device in response to a determination that estimated time differences between visiting locations along the candidate travel route and corresponding visiting locations along a previous travel route previously employed by the device (e.g., a first estimated time difference between a first visit time for the device to reach a first location along the candidate travel route and a second visit time for the device to reach the first location along the previous travel route, a second estimated time difference between a third visit time for the device to reach a second location along the candidate travel route and a fourth visit time for the device to reach the second location along the previous travel route, etc.) satisfy a first defined criterion. Additionally or alternatively, the candidate travel route can be employed by the device in response to a determination that a difference between the candidate travel route and the previous travel route previously employed by the device is within a certain degree of difference. However, another candidate travel route can be selected from the set of candidate travel routes in response to a determination that the candidate travel route does not satisfy the one or more security conditions. For example, another candidate travel route can be selected from the set of candidate travel routes until a particular candidate travel route satisfies the one or more security conditions. As such, a time to patrol an entire travel route can be minimized, an interval for visiting certain locations along a travel route can be minimized and/or at least a portion of a travel route can be randomized. Moreover, monitoring performed by a surveillance system can be improved and/or likelihood of prediction of a travel route by an entity (e.g., an entity within the geographic area) can be reduced.

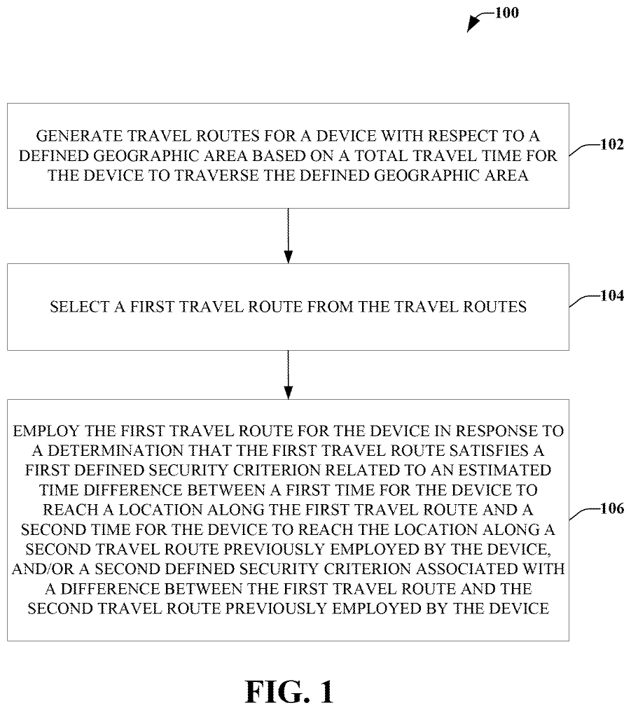

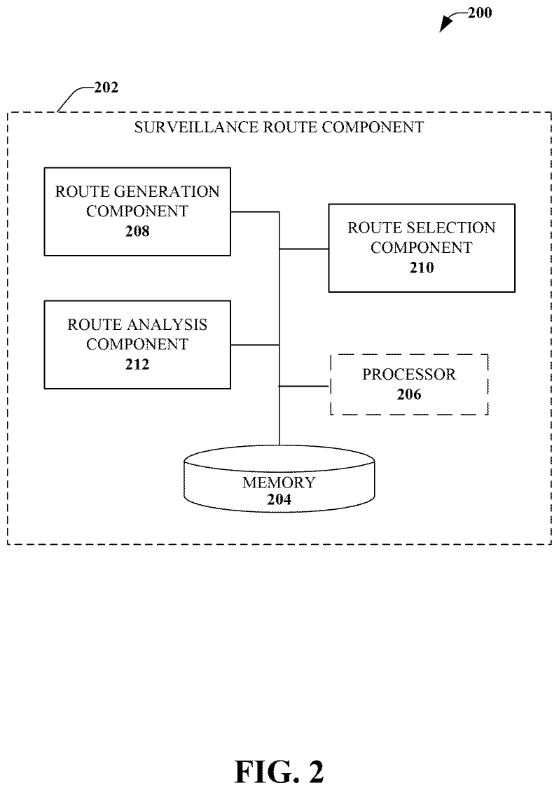

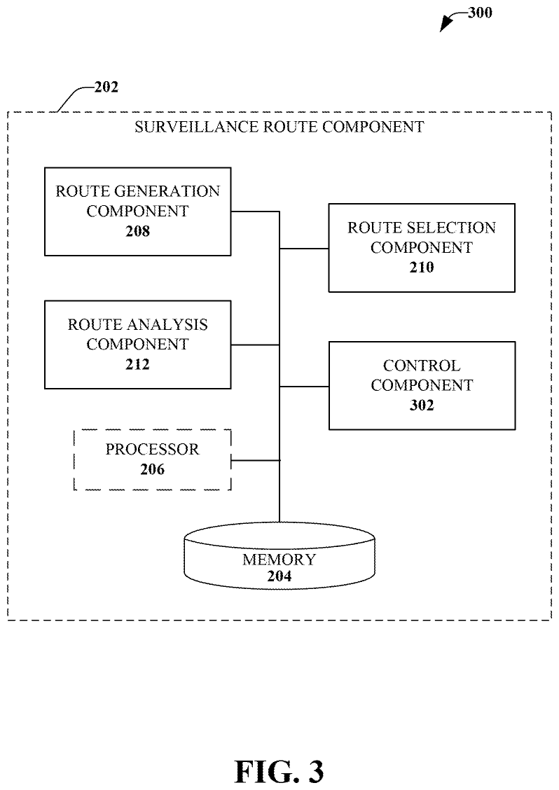

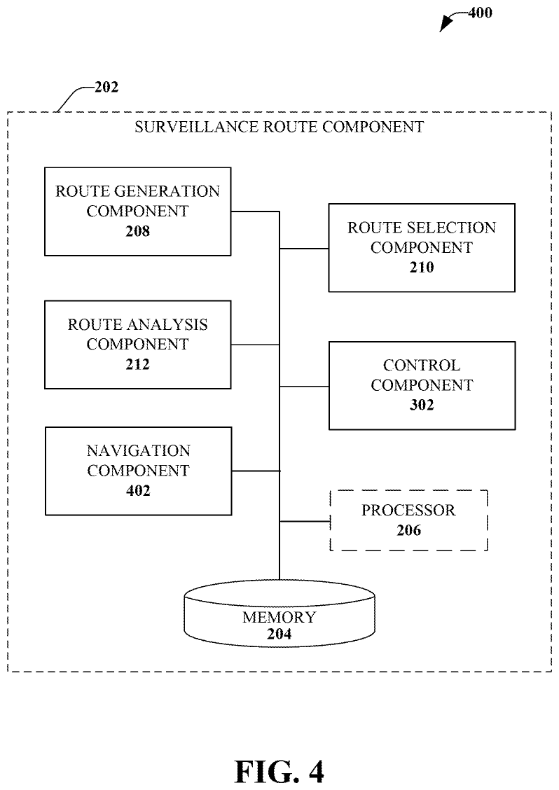

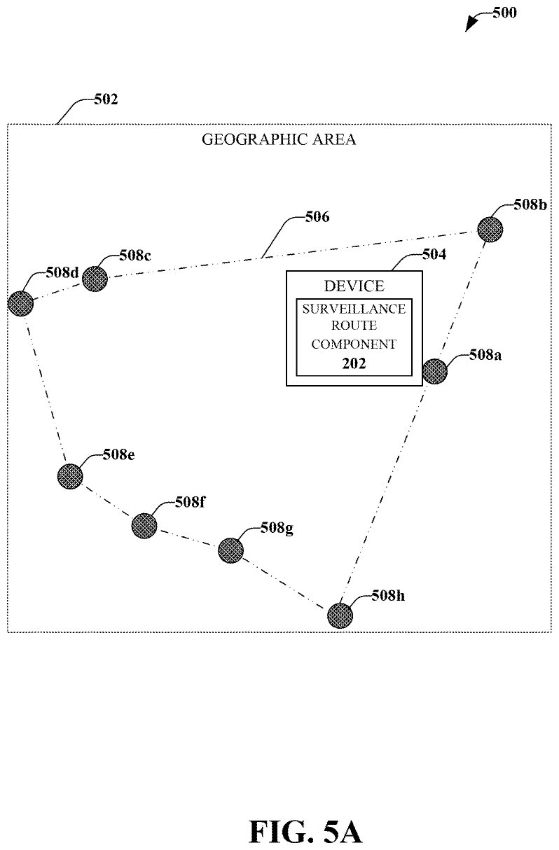

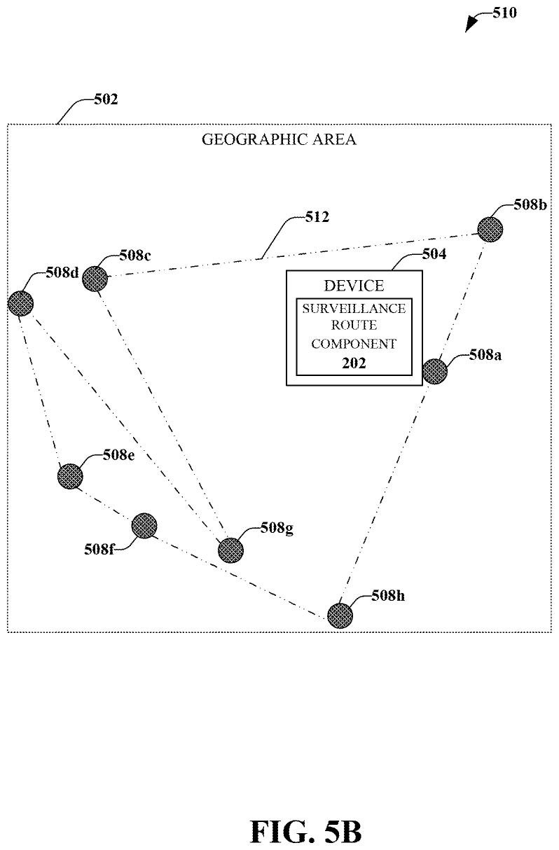

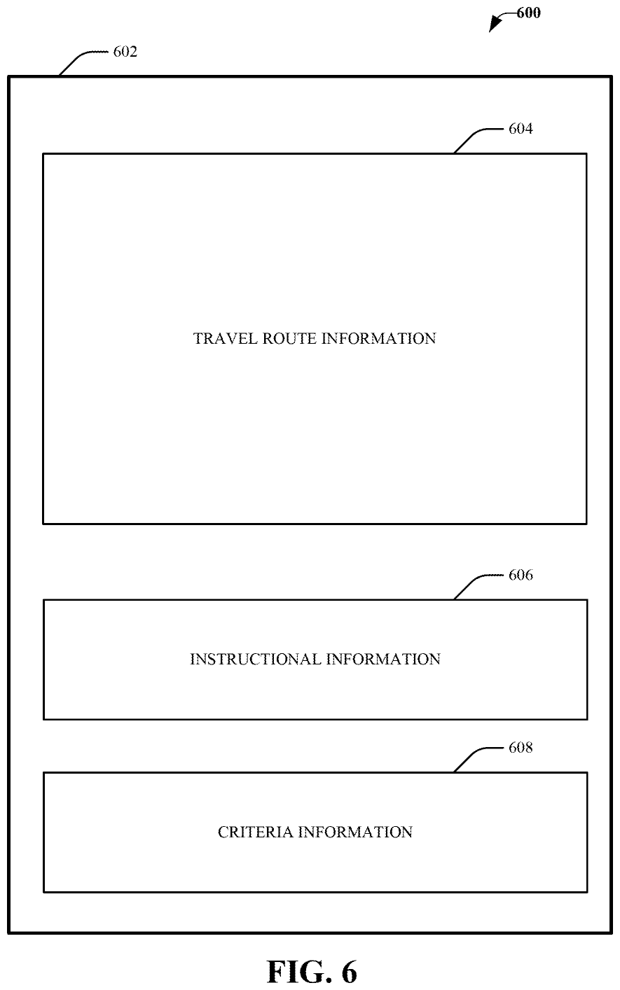

FIG. 1 illustrates an example, non-limiting embodiment of a method 100 to manage and/or generate a travel route for a device with respect to a geographic area. In an aspect, the method 100 can be associated with a surveillance system (e.g., a video surveillance system, a mobile surveillance system, a surveillance camera system, a mobile surveillance camera system, a patrol system, etc.). However, the method 100 can additionally or alternatively be associated with another type of system such as, for example, a navigation system, a global positioning system, a display system, an electronic device system, etc. The method 100 in FIG. 1 can be implemented using, for example, any of the systems, such as a system 200 (of FIG. 2), a system 300 (of FIG. 3), a system 400 (of FIG. 4), a system 500 (of FIG. 5A), a system 510 (of FIG. 5B), a system 600 (of FIG. 6), etc., further described herein below. The method 100 may include one or more operations, functions or actions as illustrated by one or more of blocks 102, 104 and/or 106.

Beginning at block 102, travel routes for a device with respect to a defined geographic area are generated based on a total travel time for the device to traverse the defined geographic area. The device can be an electronic device such as, for example, a camera device. The device can include one or more sensors configured to capture video information. In an embodiment, the device can be attached to a human patroller. For example, the device can include a display that can present information to the human patroller. In another embodiment, the device can be attached to a drone device (e.g., a quadcopter). For example, the device can autonomously control flight of the drone device. The geographic area can be a geographic location with defined boundaries. The device and/or the travel routes can be confined to the geographic area. The travel routes can include two or more travel routes. The travel routes can be candidate travel routes for the device. Furthermore, the travel routes can be patrol routes that satisfy a defined total travel time for the device to travel through the geographic area. The total travel time can be a total route time condition for the device to traverse the defined geographic area. For example, if a target total travel time along a travel route is Tₒₚₜ and a defined additional time to travel along the travel route is Tₐₗₚₕₐ, multiple travel routes that satisfy a total travel time<Tₒₚₜ+Tₐₗₚₕₐ can be obtained.

In an aspect, the travel routes can include a set of defined locations within the geographic area. For example, the set of defined locations can be waypoint locations (e.g., geographic destinations) for the device. At least a travel route and another travel route from the travel routes can include a corresponding set of defined locations. For example, a travel route and another travel route from the travel routes can include a corresponding set of defined locations, but different sub-routes that connect the corresponding set of defined locations. Additionally or alternatively, at least a travel route and another travel route from the travel routes can include a different set of defined locations. In an embodiment, the set of defined locations within the geographic area can be predetermined and/or stored in a data store. For example, the set of defined locations can be points of interest and/or defined by a user. In another embodiment, the set of defined locations can be determined based analysis of the geographic area. For example, one or more artificial intelligence techniques can be employed to determine the set of defined locations. To facilitate determination of the set of defined locations, principles of artificial intelligence can be employed to facilitate extracting correlations, inferences and/or mathematical expressions with respect to the geographic area. In an aspect, a support vector machine (SVM) classifier can be employed to learn and/or generate inferences associated with the geographic area. Additionally or alternatively, other classification techniques associated with Bayesian networks, decision trees and/or probabilistic classification models can be employed to determine the set of defined locations. Classifiers can be explicitly trained (e.g., via a generic training data) as well as implicitly trained (e.g., via receiving extrinsic information). For example, with respect to SVM's, SVM's can be configured via a learning or training phase within a classifier constructor and feature selection module. A classifier can be a function that maps an input attribute vector, x=(x1, x2, x3, x4, xn), to a confidence that the input belongs to a class—that is, f(x)=confidence(class).

Inference based schemes can also be employed to facilitate analysis of the geographic area and/or determination of the set of defined locations. For example, machine-learning based techniques, statistical-based techniques and/or probabilistic-based techniques can be employed to analyze the geographic area and/or determine the set of defined locations. In a non-limiting example, expert systems, fuzzy logic, SVMs, Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, a set of clustering machine learning computations, a set of decision tree machine learning computations, a set of instance-based machine learning computations, a set of regression machine learning computations, a set of regularization machine learning computations, a set of rule learning machine learning computations, a set of Bayesian machine learning computations, a set of deep Boltzmann machine computations, a set of deep belief network computations and/or a set of different machine learning computations can be employed to analyze the geographic area and/or determine the set of defined locations.

The travel routes can be generated based on a route generator. In one example, the travel routes can be generated based on a travelling salesman problem technique where the set of defined locations are modeled as a weighted graph. For example, the set of defined locations can correspond to a set of vertices on a graph and paths between the set of defined locations that form a travel route can correspond to a set of edges on the graph that connect the set of vertices. The travelling salesman technique can additionally or alternatively generate and/or compare a set of travel routes associated with a degree of difference that satisfies a defined criterion. For example, a first set of defined locations for a travel route from the set of travel routes can correspond to a second set of defined locations for another travel route from the set of travel routes. However, a first set of sub-routes that connect the first set of defined locations can be different than a second set of sub-routes that connect the second set of defined locations. The route generator can employ one or more algorithms to generate the travel routes such as, for example, a heuristic path algorithm that performs learning and/or problem solving techniques associated with a search of a graph associated with the set of defined locations, Help-Karp algorithm that recursively determines a shortest path between the set of defined locations, a greedy algorithm that determines a shortest path between the set of defined locations, a local search algorithm that minimizes a total length of a travel route along the set of defined locations, a nearest neighbor algorithm that determines a nearest defined with respect to a current defined location, another type of route generation algorithm, etc. In an aspect, a defined location along a travel route can be associated with a visit time interval. For example, the visit time interval can be an interval of time in which the device stays at the defined location. One or more locations from the set of defined locations can be associated with a unique visit time interval. Additionally or alternatively, two or more locations from the set of defined locations can be associated with a corresponding visit time interval. Block 102 may be followed by block 104.

At block 104, a first travel route is selected from the travel routes. In an embodiment, the first travel route can be randomly selected from the travel routes. For example, the first travel route can be selected from the travel routes based on a random sampling technique and/or a random number assigned to each travel route. Block 104 may be followed by block 106.

At block 106, the first travel route is employed for the device in response to a determination that the first travel route satisfies a first defined security criterion related to an estimated time difference between a first time for the device to reach a location along the first travel route and a second time for the device to reach the location along a second travel route previously employed by the device. Additionally or alternatively, the first travel route is employed for the device in response to a determination that the first travel route satisfies a second defined security criterion associated with a difference between the first travel route and the second travel route previously employed by the device. The location can be included in the set of defined locations for the travel route. Furthermore, the first travel route and the second travel route can include a corresponding set of defined locations. For example, the first travel route and the second travel route can include a corresponding set of defined locations, but different sub-routes that connect the corresponding set of defined locations. Additionally or alternatively, at least one location associated with the second travel route can be different than a particular location associated the first travel route.

The first defined security criterion can be associated with a visit time interval condition. In one example, the first defined security criterion can be associated with a defined threshold value for the estimated time difference between the first time for the device to reach the location along the first travel route and the second time for the device to reach the location along the second travel route previously employed by the device. The first defined security criterion can be employed to verify that the estimated time difference between the first time and the second time is below a certain time difference. Therefore, the travel route can be employed for the device in response to a determination that the estimated time difference is below the defined threshold value. Moreover, by employing the first defined security criterion, a time difference between the first time and the second time can be minimized. Therefore, the device can reach each location associated with the first travel route at approximately a same time as each location associated with the second travel route. The estimated time difference can be estimated, for example, based on a distance between the location and another location associated with the first travel route, conditions associated with the device (e.g., speed of the device, acceleration of the device, size of the device, weight of the device, etc.), specifications associated with the device (e.g., specifications for components included in the device, types of components included in the device, etc.), and/or predetermined data stored in a data store (e.g., an average walking speed of a human patroller, etc.). The first defined security criterion can also be associated with other locations included in the set of defined locations. For example, the first travel route can be employed for the device in response to a determination that all estimated time differences between locations in the set of defined locations for the first travel route and other locations associated with the second travel route are below the defined threshold value. In an aspect, the estimated time difference can include a visit time interval associated with the location along the first travel route. The visit time interval can be an interval of time in which the device stays at the location along the first travel route.

The second defined security criterion can be associated with a degree of route randomness condition. For example, the second defined security criterion can be associated with a defined difference between the first travel route and the second travel route previously employed by the device. The defined difference can be a difference between sub-routes that connect the set of defined locations for the first travel route and a corresponding set of defined locations for the second travel route. Additionally or alternatively, the defined difference can be determined based on intervals of time for the device to travel between locations associated with the first travel route and/or the second travel route (e.g., an interval of time for the device to travel between at least a first location along the first travel route and a second location along the first travel route, etc.). Additionally or alternatively, the defined difference can be a difference between visit time intervals associated with the set of defined locations for the first travel route and other visit time intervals associated with a corresponding set of defined locations for the second travel route. The second defined security criterion can be employed to verify that a difference between the first travel route and the second travel route (e.g., the second travel route previously employed by the device) is above a certain degree of difference. In one example, a Euclidean difference can be determined between the first travel route and the second travel route previously employed by the device. Therefore, the second defined security criterion can be satisfied if the Euclidean difference is above a defined Euclidean difference value. However, it is to be appreciated that other difference techniques can be employed such as, but not limited to, a Manhattan distance, a Minkowski distance, a Chebyshev distance, a Mahalanobis distance, a Canberra distance, a Hamming distance, another type of distance technique, etc.

In an embodiment, the first travel route can be associated with a set of travel routes for the device. For example, a set of travel routes that includes the first travel route and one or more other travel routes can be presented on a display of the device. Furthermore, in certain embodiments, a user can select the first travel route from the set of travel routes using the display. In another embodiment, a geographic location of the device can be controlled based on the first travel route in response to the determination that the first travel route satisfies the first defined security criterion and/or the second defined security criterion. For example, navigation of the device can be autonomously controlled based on the first travel route in response to the determination that the first travel route satisfies the first defined security criterion and/or the second defined security criterion. Navigation of the device can include, but is not limited to, control of a driving pattern of the device, a flight pattern of the device, a navigation pattern of the device, a speed of the device, acceleration of the device, deceleration of the device, an interval of time for the device to stop at a location, altitude of the device, a direction of the device, etc.

In another embodiment, geographic locations (e.g., geographic destinations) associated with the first travel route can be displayed on a display of the device in response to the determination that the first travel route satisfies the first defined security criterion and/or the second defined security criterion. For example, navigational instructions can be displayed on a display of the device in response to the determination that the first travel route satisfies the first defined security criterion and/or the second defined security criterion. The navigational instructions can include, but is not limited to, voice-commands, written commands, pictures, maps, three-dimensional (3D) imagery, graphical elements (e.g., arrows, etc.), a time counter, display of a distance to reach a next location, etc.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments. For example, in an embodiment, a single travel route can be generated for the device at block 102. Therefore, the method 100 can be implemented without block 104 in certain embodiments (e.g., block 106 may be followed by block 102 in certain embodiments).

Turning now to FIG. 2, illustrated is an example, non-limiting embodiment of the system 200 to manage and/or generate a travel route for a device with respect to a geographic area. The system 200 can be associated with a surveillance route system (e.g., a travel route system). For example, the system 200 can be associated with a video surveillance system, a mobile surveillance system, a surveillance camera system, a mobile surveillance camera system, a patrol system, a navigation system, a global positioning system, a display system, an electronic device system, another type of system, etc. In an embodiment, the system 200 can be included in an electronic device. The electronic device can be, for example, a camera device that includes one or more sensors to capture video information. The electronic device can be attached to an entity such as, for example, a human patroller or a drone device (e.g., a quadcopter). Alternatively, the electronic device can be included in another electronic device (e.g., a drone device, a vehicle, etc.).

The system 200 can include a surveillance route component 202. The surveillance route component 202 can include at least one memory 204 that can store computer-executable components and instructions. The surveillance route component 202 can also include at least one processor 206, communicatively coupled to the at least one memory 204. Coupling can include various communications including, but not limited to, direct communications, indirect communications, wired communications, and/or wireless communications. The at least one processor 206 can be operable to execute or facilitate execution of one or more of the computer-executable components stored in the memory 204. The processor 206 can be directly involved in the execution of the computer-executable component(s), according to an aspect. Additionally or alternatively, the processor 206 can be indirectly involved in the execution of the computer executable component(s). For example, the processor 206 can direct one or more components to perform the operations.

It is noted that although one or more computer-executable components can be described herein and illustrated as components separate from the memory 204 (e.g., operatively connected to memory), in accordance with various embodiments, the one or more computer-executable components might be stored in the memory 204. Further, while various components have been illustrated as separate components, it will be appreciated that multiple components can be implemented as a single component, or a single component can be implemented as multiple components, without departing from example embodiments.

The surveillance route component 202 can also include a route generation component 208, a route selection component 210 and/or a route analysis component 212. The route generation component 208 can generate a set of travel routes with respect to a defined geographic area. In an aspect, the route generation component 208 can generate the set of travel routes based on a defined criterion associated with a total travel time for an electronic device to travel through the defined geographic area. For example, the defined criterion can be a defined threshold value associated with the total travel time. Therefore, a travel route from the set of travel routes can include a particular total travel time that is less than the defined threshold value. Furthermore, a travel route from the set of travel routes can include a set of defined locations within the defined geographic area. Defined locations determined and/or generated by the route generation component 208 can be associated with visit time intervals. One or more defined locations determined and/or generated by the route generation component 208 can be associated with a unique visit time interval and/or corresponding visit time intervals.

In an embodiment, the set of defined locations within the geographic area can be predetermined and/or stored in a memory (e.g., the memory 204 or another memory in communication with the surveillance route component 202). In another embodiment, the set of defined locations can be determined based analysis of the defined geographic area. The route generation component 208 can employ one or more artificial intelligence techniques to determine the set of defined locations. For example, the route generation component 208 can employ principles of artificial intelligence to facilitate extracting correlations, inferences and/or mathematical expressions with respect to the defined geographic area and/or the set of defined locations.

The route generation component 208 can employ various artificial intelligence techniques to learn and/or generate inferences associated with the geographic area and/or the set of defined locations such as, but not limited to, a SVM classifier, machine-learning based techniques, statistical-based techniques, probabilistic-based techniques, expert systems, fuzzy logic, SVMs, HMMs, greedy search algorithms, rule-based systems, Bayesian models (e.g., Bayesian networks), neural networks, other non-linear training techniques, data fusion, utility-based analytical systems, a set of clustering machine learning computations, a set of decision tree machine learning computations, a set of instance-based machine learning computations, a set of regression machine learning computations, a set of regularization machine learning computations, a set of rule learning machine learning computations, etc.

In an aspect, the route generation component 208 can generate the set of travel routes based on a travelling salesman problem technique where the set of defined locations are modeled as a weighted graph. The route generation component 208 can additionally or alternatively employ one or more algorithms to generate the set of travel routes such as, for example, a heuristic path algorithm that performs learning and/or problem solving techniques associated with a search of a graph associated with the set of defined locations, Help-Karp algorithm that recursively determines a shortest path between the set of defined locations, a greedy algorithm that determines a shortest path between the set of defined locations, a local search algorithm that minimizes a total length of a travel route along the set of defined locations, a nearest neighbor algorithm that determines a nearest defined with respect to a current defined location, another type of route generation algorithm, etc.

The route selection component 210 can select a first travel route from the set of travel routes. For example, the route selection component 210 can randomly select the first travel route from the set of travel routes. The route selection component 210 can randomly select the first travel route from the set of travel routes based on a random sampling technique. In one example, the route selection component 210 can randomly select the first travel route from the set of travel routes based on a simple random sample algorithm that randomly selects the first travel route from the set of travel routes during a sampling process. However, it is to be appreciated that the route selection component 210 can randomly select the first travel route from the set of travel routes based on a different technique.

The route analysis component 212 can analyze a travel route selected by the route selection component 210. In an aspect, the route analysis component 212 can analyze the first travel route selected from the set of travel routes. The route analysis component 212 can analyze the first travel route based on at least one defined security criterion. In an embodiment, the route analysis component 212 can analyze the first travel route based on a first defined security criterion associated with a first time difference (e.g., a first estimated time difference) between at least a first time for the electronic device to reach a location along the first travel route and a second time for the electronic device to reach the location along a second travel route previously employed by the electronic device. The route analysis component 212 can also analyze the first travel route based on a second time difference (e.g., a second estimated time difference) between a third time for the electronic device to reach another location along the first travel route and a fourth time for the electronic device to reach the other location along the second travel route previously employed by the electronic device, etc. until all locations along the first travel route are analyzed with respect to locations along the second travel route.

Additionally or alternatively, the route analysis component 212 can analyze the first travel route based on a second defined security criterion associated with a difference between the first travel route and a previous travel route that is previously employed by the electronic device. The previous travel route can be a travel route that is not included in the set of travel routes associated with the first travel route. In one example, the route analysis component 212 can determine a Euclidean distance, a Manhattan distance, a Minkowski distance, a Chebyshev distance, a Mahalanobis distance, a Canberra distance and/or a Hamming distance between the first travel route and a previous travel route. For example, the route analysis component 212 can employ a Euclidean distance, a Manhattan distance, a Minkowski distance, a Chebyshev distance, a Mahalanobis distance, a Canberra distance and/or a Hamming distance to determine a difference between sub-routes that connect the set of defined locations for the first travel route and other sub-routes that connect the set of defined locations for the second travel route. The route analysis component 212 can provide the first travel route to the electronic device in response to a determination that the first travel route satisfies the first defined security criterion and/or the second defined security criterion.

In an aspect, the route selection component 210 can select a travel route from the set of travel routes that is different than the first travel route selected by the route selection component 210. For example, the route selection component 210 can select a third travel route from the set of travel routes (e.g., a third travel route that is different than the first travel route selected from the set of travel routes and the second travel route previously employed by the electronic device) in response to a determination that the first travel route does not satisfy the first defined security criterion and/or the second defined security criterion. The third travel route selected from the set of travel routes can be another travel route that is selected from the set of travel routes and the third travel route can be different than the first travel route selected from the set of travel routes. Furthermore, the route analysis component 212 can analyze the third travel route based on the first defined security criterion and/or the second defined security criterion. The route analysis component 212 can provide the third travel route (e.g., rather than the first travel route) to the electronic device in response to a determination that the third travel route satisfies the first defined security criterion and/or the second defined security criterion. For example, the route analysis component 212 can provide the third travel route to the electronic device in response to a determination that the third travel route satisfies a defined security criterion associated with a time difference (e.g., an estimated time difference) between at least a particular time for the electronic device to reach the location along the third travel route and the second time for the electronic device to reach the location along the second travel route previously employed by the electronic device. Additionally or alternatively, the route analysis component 212 can provide the third travel route to the electronic device in response to a determination that the third travel route satisfies a defined security criterion associated with a difference between the third travel route and the previous travel route that is previously employed by the electronic device.

FIG. 3 illustrates an example, non-limiting embodiment of the system 300 to manage and/or generate a travel route for a device with respect to a geographic area. The system 300 can be associated with a surveillance route system (e.g., a travel route system). For example, the system 300 can be associated with a video surveillance system, a mobile surveillance system, a surveillance camera system, a mobile surveillance camera system, a patrol system, a navigation system, a global positioning system, a display system, an electronic device system, another type of system, etc. The system 300 can include the surveillance route component 202. The surveillance route component 202 can include the memory 204, the processor 206, the route generation component 208, the route selection component 210, the route analysis component 212 and/or a control component 302.

The control component 302 can be associated with an electronic device. The electronic device can be, for example, a camera device that includes one or more sensors to capture video information. In an embodiment, the electronic device can be attached to or included in a moveable electronic device such as, for example, a drone device (e.g., a quadcopter) or a vehicle. In another embodiment, the electronic device (e.g., the control component 302 associated with the electronic device) can be in communication with the moveable electronic device. The control component 302 can control a geographic location of the electronic device and/or the moveable electronic device associated with the electronic device based on a travel route determined to satisfy the first defined security criterion and/or the second defined security criterion. For example, the control component 302 can control a geographic location of the electronic device and/or the moveable electronic device associated with the electronic device based on the first travel route (e.g., the first travel route selected by the route selection component 210 and/or analyzed by the route analysis component 212) in response to the determination that the first travel route satisfies the first defined security criterion and/or the second defined security criterion.

In an aspect, the control component 302 can autonomously control a geographic location of the electronic device and/or the moveable electronic device associated with the electronic device based on a travel route (e.g., the first travel route, etc.) determined to satisfy the first defined security criterion and/or the second defined security criterion. For example, the control component 302 can autonomously control navigational direction of the electronic device and/or the moveable electronic device associated with the electronic device based on a travel route (e.g., the first travel route, etc.) determined to satisfy the first defined security criterion and/or the second defined security criterion. In a non-limiting example, the control component 302 can autonomously control a driving pattern of the device, a flight pattern of the device, a navigation pattern of the device, a speed of the device, acceleration of the device, deceleration of the device, an interval of time for the device to stop at a location, altitude of the device, a direction of the device, and/or other navigational aspects of the electronic device and/or the moveable electronic device based on a travel route (e.g., the first travel route, etc.) determined to satisfy the first defined security criterion and/or the second defined security criterion. In certain embodiments, the control component 302 can autonomously control a geographic location of the electronic device and/or the moveable electronic device associated with the electronic device based on one or more other travel routes determined for one or more other electronic devices. For instance, multiple electronic devices can be controlled to facilitate patrolling of a geographic area in cooperation, where one or more locations in the geographic area can be patrolled and/or shared by the multiple electronic devices.

FIG. 4 illustrates an example, non-limiting embodiment of the system 400 to manage and/or generate a travel route for a device with respect to a geographic area. The system 400 can be associated with a surveillance route system (e.g., a travel route system). For example, the system 400 can be associated with a video surveillance system, a mobile surveillance system, a surveillance camera system, a mobile surveillance camera system, a patrol system, a navigation system, a global positioning system, a display system, an electronic device system, another type of system, etc. The system 400 can include the surveillance route component 202. The surveillance route component 202 can include the memory 204, the processor 206, the route generation component 208, the route selection component 210, the route analysis component 212, the control component 302 and/or a navigation component 402.

The navigation component 402 can be associated with an electronic device. The electronic device can be, for example, a camera device that includes one or more sensors to capture video information. In an embodiment, the electronic device can be attached to or included in a moveable electronic device such as, for example, a moveable electronic device attached to a human patroller. In another embodiment, the electronic device (e.g., the navigation component 402 associated with the electronic device) can be in communication with the moveable electronic device.

The navigation component 402 can display a set of navigation instructions associated with a travel route on a display of the electronic device. For example, the navigation component 402 can display a set of navigation instructions associated with the first travel route on a display of the electronic device based on information associated with the first travel route (e.g., the first travel route selected by the route selection component 210 and/or analyzed by the route analysis component 212). The set of navigation instructions can be, for example, navigational directions associated with the first travel route.

In an aspect, the navigation component 402 can generate and/or display a set of navigation instructions associated with a travel route (e.g., the first travel route) on a display of the electronic device in response to the determination that the travel route (e.g., the first travel route) satisfies the first defined security criterion and/or the second defined security criterion. For example, the navigation component 402 can generate and/or display voice-commands, written commands, pictures, maps, 3D imagery, graphical elements (e.g., arrows, etc.), a time counter, display of a distance to reach a next location and/or other navigational instructions in response to the determination that the first travel route satisfies the first defined security criterion and/or the second defined security criterion. In an embodiment, the navigation component 402 can alter a travel route during display of a set of navigation instructions on a display of the electronic device. For example, in response to a determination that a status of a travel route is altered and/or that a command signal is received (e.g., a command signal that indicates that a situation with respect to a travel route and/or a geographic area has changed), the navigation component 402 can determine one or more new locations for the travel route. As such, a travel route and/or a set of navigation instructions can be dynamically altered. In another embodiment, the navigation component 402 can present a set of travel routes on a display of the electronic device in response to a determination that travel routes from the set of travels routes satisfy the first defined security criterion and/or the second defined security criterion. The set of travel routes can facilitate selection of a travel route by a user via the display of the electronic device. In yet another embodiment, the navigation component 402 can generate an alert for presentation on a display of the electronic device in response to a determination that a location of the electronic device satisfies a defined criterion with respect to the set of navigation instructions and/or a travel route (e.g., the first travel route) presented on the display of the electronic device. For instance, the navigation component 402 can generate an alert for presentation on a display of the electronic device in response to a determination that the electronic device has strayed from a travel route (e.g., the first travel route) for the electronic device. In certain embodiments, the navigation component 402 can generate and/or display a set of navigation instructions based on one or more other sets of navigation instructions determined for one or more other electronic devices. For instance, multiple electronic devices can be controlled to facilitate patrolling of a geographic area by the multiple electronic devices, where one or more locations in the geographic area can be patrolled and/or shared among the multiple electronic devices.

FIG. 5A illustrates an example, non-limiting embodiment of the system 500. The system 500 includes a geographic area 502. The geographic area 502 can be a geographic location that includes a device 504. In the embodiment shown in FIG. 5A, the device 504 can be associated with a travel route 506 to allow the device 504 to traverse the geographic area 502. The travel route 506 can be, for example, a navigation path for the device 504. The travel route 506 can also be associated with a set of locations (e.g., a set of geographic locations, a set of destinations, as set of geographic destinations). For example, the travel route 506 can include locations 508a-h. The device 504 can be, for example, a display device such as, but not limited to, a computing device, a camera device, a smart device, a mobile device, a handheld device, a portable computing device or another type of display device. The device 504 can also include the surveillance route component 202. Furthermore, the device 504 can be a device (e.g., an electronic device) associated with the method 100, the system 200, the system 300, the system 400 and/or other methods disclosed herein.

FIG. 5B illustrates an example, non-limiting embodiment of the system 510. The system 510 also includes the geographic area 502 and the device 504. In the embodiment shown in FIG. 5B, the device 504 can be associated with a travel route 512 to allow the device 504 to traverse the geographic area 502. The travel route 512 can be, for example, a navigation path for the device 504. The travel route 512 can also be associated with the locations 508a-h (e.g., the travel route 512 can include the locations 508a-h). However, sub-routes of the travel route 512 that connect the locations 508a-h can be different than other sub-routes of the travel route 506 that connect the locations 508a-h. For example, a first sub-route of the travel route 506 can connect the location 508a and the location 508b, a second sub-route of the travel route 506 can connect the location 508b and the location 508c, a third sub-route of the travel route 506 can connect the location 508c and the location 508d, a fourth sub-route of the travel route 506 can connect the location 508d and the location 508e, a fifth sub-route of the travel route 506 can connect the location 508e and the location 508f, a sixth sub-route of the travel route 506 can connect the location 508f and the location 508g, a seventh sub-route of the travel route 506 can connect the location 508g and the location 508h, and an eighth sub-route of the travel route 506 can connect the location 508h and the location 508a. In contrast, a first sub-route of the travel route 512 can connect the location 508a and the location 508b, a second sub-route of the travel route 512 can connect the location 508b and the location 508c, a third sub-route of the travel route 512 can connect the location 508c and the location 508g, a fourth sub-route of the travel route 512 can connect the location 508g and the location 508d, a fifth sub-route of the travel route 512 can connect the location 508d and the location 508e, a sixth sub-route of the travel route 506 can connect the location 508e and the location 508f, a seventh sub-route of the travel route 506 can connect the location 508f and the location 508h, and an eighth sub-route of the travel route 506 can connect the location 508h and the location 508a.

In a non-limiting example, the travel route 506 can be a travel route that is generated by the route generation component 208 and/or a travel route that is selected by the route selection component 210. Furthermore, the travel route 512 can be a travel route that is previously employed (e.g., previously utilized) by the device 504 and/or previously provided to the device 504. In an embodiment, the device 504 can employ the travel route 506 in response to a determination that the travel route 506 satisfies at least one defined security criterion associated with an estimated time difference associated with the locations 508a-h along the travel route 506 and the travel route 512. The at least one defined security criterion can be a defined threshold level for an estimated time difference. In one example, the device 504 can employ the travel route 506 in response to a determination that the travel route 506 satisfies a defined security criterion associated with a first estimated time difference between a first time for the device 504 to reach the location 508a along the travel route 506 and a second time for the device 504 to reach the location 508a along the travel route 512, a second estimated time difference between a third time for the device 504 to reach the location 508b along the travel route 506 and a fourth time for the device 504 to reach the location 508b along the travel route 512, a third estimated time difference between a fifth time for the device 504 to reach the location 508c along the travel route 506 and a sixth time for the device 504 to reach the location 508c along the travel route 512, a fourth estimated time difference between a seventh time for the device 504 to reach the location 508d along the travel route 506 and a eighth time for the device 504 to reach the location 508d along the travel route 512, a fifth estimated time difference between a ninth time for the device 504 to reach the location 508e along the travel route 506 and a tenth time for the device 504 to reach the location 508e along the travel route 512, a sixth estimated time difference between a eleventh time for the device 504 to reach the location 508f along the travel route 506 and a twelfth time for the device 504 to reach the location 508f along the travel route 512, a seventh estimated time difference between a thirteenth time for the device 504 to reach the location 508g along the travel route 506 and a fourteenth time for the device 504 to reach the location 508g along the travel route 512, and/or a eighth estimated time difference between a fifteenth time for the device 504 to reach the location 508h along the travel route 506 and a sixteenth time for the device 504 to reach the location 508h along the travel route 512. For instance, the device 504 can employ the travel route 506 in response to a determination that the first estimated time difference between the first time for the device 504 to reach the location 508a along the travel route 506 and the second time for the device 504 to reach the location 508a along the travel route 512 is below a defined time interval threshold, that the second estimated time difference between the third time for the device 504 to reach the location 508b along the travel route 506 and the fourth time for the device 504 to reach the location 508b along the travel route 512 is below the defined time interval threshold, etc. As such, a time interval between a k-th location of an n-th travel route and a corresponding (k-th) location of a previous (n-1-th) travel route can be employed as an estimated time difference, where n and k are integers. Furthermore, the device 504 can employ a travel route, for example, in response to a determination that an absolute value of (time_location1_first travel route−time_location1_second travel route) is less than a defined time interval threshold. Accordingly, it can be more difficult for an entity (e.g., a person or a device) to predict a travel route employed by the device 504 since the device 504 does not repeatedly arrive at a particular location at approximately a same time while patrolling the geographic area 502.

In one example, a particular time for the device 504 to reach a particular location (e.g., a particular location 508a-h) along the travel route 506 and/or the travel route 514 can be determined based on an interval of time for the device 504 to reach the particular location. For example, an estimated time for the device 504 to reach the location 508b can be an amount of time for the device 504 to travel from the location 508a to the location 508b, an estimated time for the device 504 to reach the location 508c can be equal to the amount of time and another amount of time for the device 504 to travel from the location 508b to the location 508c, etc. Additionally or alternatively, an estimated time for the device 504 to reach the location 508b can be determined based on an interval of time in which the device 504 stays at the location 508a, an estimated time for the device 504 to reach the location 508c can be determined based on an interval of time in which the device 504 stays at the location 508b, etc. As such, the device 504 can employ the travel route 506 in response to a determination that the travel route 506 satisfies at least one defined security criterion associated with a first comparison between a first interval of time for the device 504 to visit the location 508b along the travel route 506 and a second interval of time for the device 504 to visit the location 508b along the travel route 512, a second comparison between a third interval of time for the device 504 to visit the location 508c along the travel route 506 and a fourth interval of time for the device 504 to visit the location 508c along the travel route 512, a third comparison between a fifth interval of time for the device 504 to visit the location 508d along the travel route 506 and a sixth interval of time for the device 504 to visit the location 508d along the travel route 512, a fourth comparison between a seventh interval of time for the device 504 to visit the location 508e along the travel route 506 and a eighth interval of time for the device 504 to visit the location 508e along the travel route 512, a fifth comparison between a ninth interval of time for the device 504 to visit the location 508f along the travel route 506 and a tenth interval of time for the device 504 to visit the location 508f along the travel route 512, a sixth comparison between a eleventh interval of time for the device 504 to visit the location 508g along the travel route 506 and a twelfth interval of time for the device 504 to visit the location 508g along the travel route 512, and/or a seventh comparison between a thirteenth interval of time for the device 504 to visit the location 508h along the travel route 506 and a fourteenth interval of time for the device 504 to visit the location 508h along the travel route 512.

Additionally or alternatively, the device 504 can employ the travel route 506 in response to a determination that the travel route 506 satisfies a defined security criterion associated with a difference between the travel route 506 and the travel route 512. For example, the device 504 can employ the travel route 506 in response to a determination that a difference between sub-routes that connect the locations 508a-h for the travel route 506 and other sub-routes that connect the locations 508a-h for the travel route 512 satisfies a defined criterion. In one example, the device 504 can employ the travel route 506 in response to a determination that a Euclidean distance between the travel route 506 and the travel route 512 satisfies a defined criterion, a Manhattan distance between the travel route 506 and the travel route 512 satisfies a defined criterion, a Minkowski distance between the travel route 506 and the travel route 512 satisfies a defined criterion, a Chebyshev distance between the travel route 506 and the travel route 512 satisfies a defined criterion, a Mahalanobis distance between the travel route 506 and the travel route 512 satisfies a defined criterion, a Canberra distance between the travel route 506 and the travel route 512 satisfies a defined criterion, and/or a Hamming distance between the travel route 506 and the travel route 512 satisfies a defined criterion.

Additionally, in certain embodiments, the device 504 can employ the travel route 506 in response to a determination that the travel route 506 satisfies other defined security criterion. For instance, the device 504 can additionally employ the travel route 506 based on analytical information associated with the geographic area 502, census demographic information associated with the geographic area 502, crime information associated with the geographic area 502, geographic information associated with the geographic area 502, other information associated with the geographic area 502, etc. In one example, the travel route 506 can be selected, the travel route 506 can be analyzed, and/or time values associated with the locations 508a-h can be determined based on a crime map associated with the geographic area 502. For example, a particular time for the device 504 to reach the location 508a-h can be weighted based on crime data included in a crime map. In another example, an importance factor for a particular location from the locations 508a-h and/or an interval of time in which the device 504 stays at a particular location from the locations 508a-h can be determined based on a crime map associated with the geographic area 502. However, it is to be appreciated that the travel route 506 can be selected, the travel route 506 can be analyzed, and/or time values associated with the locations 508a-h can be determined based on other information associated with the geographic area 502.

Referring to FIG. 6, there is illustrated a non-limiting implementation of the system 600, in accordance with various aspects and implementations of this disclosure. The system 600 illustrates an example user interface 602. The user interface 602 can be a graphical user interface that presents (e.g., displays) graphical elements. In an embodiment, the system 600 can be associated with the device 504. For example, the user interface 602 can be presented on a display of the device 504. In one example, the user interface 602 can be associated with an application (e.g., a Global Positioning System (GPS) application, a navigation application, a map application, another type of interactive application, etc.).

In an aspect, the user interface 602 can present travel route information 604. The travel route information 604 can be associated with information generated by the surveillance route component 202. For example, the travel route information 604 can present information related to a travel route for a device (e.g., the device 504) associated with the user interface 602. The travel route information 604 can be presented in a human interpretable format. The travel route information 604 can also be presented to allow a human to interact to with the travel route and/or information associated with the travel route. For example, the travel route information 604 can be presented as a graphical element such as, but not limited to, pictures (e.g., interactive pictures), an interactive map, maps, 3D imagery, graphical elements (e.g., arrows, etc.), a notification, a message, an icon, a thumbnail, a dialog box, an interactive tool, a widget or another type of graphical element. In one example, the travel route information 604 can include 3D data associated with a travel route for a device (e.g., the device 504) associated with the user interface 602.

In another aspect, the travel route information 604 can change as a function of a location (e.g., a geographic location) of a device (e.g., the device 504) associated with the user interface 602. For example, the travel route information 604 can be dynamically updated as a function of a location (e.g., a geographic location) of a device (e.g., the device 504) associated with the user interface 602. Instructional information 606 can also be presented on the user interface 602. The instructional information 606 can include information such as, but not limited to, instructional commands, written commands, a time counter, display of a distance to reach a next location and/or other instructional information. In certain embodiments, the user interface 602 can present criteria information 608. The criteria information 608 can include information regarding criteria employed to determine a travel route associated with the travel route information 604. For example, the criteria information 608 can allow a user to be informed regarding criteria employed to determine a travel route associated with the travel route information 604. The criteria information 608 can include visit time interval information, degree of route randomness information, timing information, a total travel time, an estimated interval of time between locations, a degree of difference, security criteria, other security information, and/or other information regarding a travel route associated with the travel route information 604. It is to be appreciated that the user interface 602 is merely an example. Therefore, the location and/or content of the travel route information 604 and/or the instructional information 606 can be varied. Furthermore, the user interface 602 can include other features, content and/or functionalities not shown in FIG. 6.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

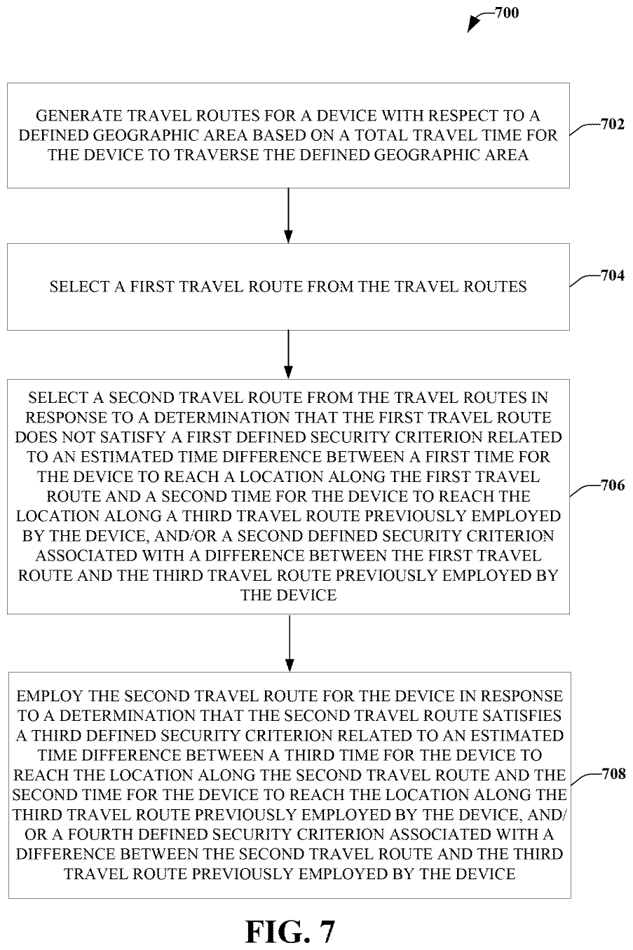

FIG. 7 illustrates an example, non-limiting embodiment of a method 700 to manage and/or generate a travel route for a device with respect to a geographic area. In an aspect, the method 700 can be associated with a surveillance system (e.g., a video surveillance system, a mobile surveillance system, a surveillance camera system, a mobile surveillance camera system, a patrol system, etc.). However, the method 700 can additionally or alternatively be associated with another type of system such as, for example, a navigation system, a global positioning system, a display system, an electronic device system, etc. The method 700 in FIG. 7 can be implemented using, for example, any of the systems, such as the system 200 (of FIG. 2), the system 300 (of FIG. 3), the system 400 (of FIG. 4), the system 500 (of FIG. 5A), the system 510 (of FIG. 5B), the system 600 (of FIG. 6), etc., described herein below. The method 700 may include one or more operations, functions or actions as illustrated by one or more of blocks 702, 704, 706 and/or 708. Beginning at block 702, travel routes for a device with respect to a defined geographic area are generated based on a total travel time for the device to traverse the defined geographic area. Block 702 may be followed by block 704. At block 704, a first travel route is selected from the travel routes. Block 704 may be followed by block 706.

At block 706, a second travel route is selected from the travel routes in response to a determination that the first travel route does not satisfy a first defined security criterion related to an estimated time difference between a first time for the device to reach a location along the first travel route and a second time for the device to reach the location along a third travel route previously employed by the device. Additionally or alternatively, the second travel route is selected from the travel routes in response to a determination that a second defined security criterion associated with a difference between the first travel route and the third travel route previously employed by the device. In an embodiment, the second travel route can be randomly selected from the travel routes. For example, the second travel route can be selected from the travel routes based on a random sampling technique and/or a random number assigned to each travel route. The second travel route selected from the travel routes can be different than the first travel route selected from the travel route. Block 706 may be followed by block 708.

At block 708, the second travel route is employed for the device in response to a determination that the second travel route satisfies a third defined security criterion related to an estimated time difference between a third time for the device to reach the location along the second travel route and the second time for the device to reach the location along the third travel route previously employed by the device. Additionally or alternatively, the second travel route is employed for the device in response to a determination that a fourth defined security criterion associated with a difference between the second travel route and the third travel route previously employed by the device. In one example, the third defined security criterion can be associated with a defined threshold value for the estimated time difference between the third time and the second time . The third defined security criterion can be employed to verify that the estimated time difference between the third time and the second time is below a certain time difference. Therefore, the second travel route can be employed for the device in response to a determination that the estimated time difference is below the defined threshold value. The third defined security criterion can also be associated with other locations included in the set of defined locations. For example, the second travel route can be employed for the device in response to a determination that all estimated time differences between locations in the second travel route and the third travel route are below the defined threshold value.

Additionally, the fourth defined security criterion can be associated with a defined difference between the second travel route and the third travel route previously employed by the device. The fourth defined security criterion can be employed to verify that a difference between the second travel route and the third travel route (e.g., the third travel route previously employed by the device) is above a certain degree of difference. In one example, a Euclidean difference can be determined between the second travel route and the third travel route previously employed by the device. Therefore, the fourth defined security criterion can be satisfied if the Euclidean difference is above a defined Euclidean difference value. However, it is to be appreciated that other difference techniques can be employed such as, but not limited to, a Manhattan distance, a Minkowski distance, a Chebyshev distance, a Mahalanobis distance, a Canberra distance, a Hamming distance, another type of distance technique, etc.

In an embodiment, a geographic location of the device can be controlled based on the second travel route in response to the determination that the second travel route satisfies the third defined security criterion and/or the fourth defined security criterion. For example, navigation of the device can be autonomously controlled based on the second travel route in response to the determination that the second travel route satisfies the third defined security criterion and/or the fourth defined security criterion. Navigation of the device can include, but is not limited to, control of a driving pattern of the device, a flight pattern of the device, a navigation pattern of the device, a speed of the device, acceleration of the device, deceleration of the device, an interval of time for the device to stop at a location, altitude of the device, a direction of the device, etc. In another embodiment, geographic destinations associated with the second travel route can be displayed on a display of the device in response to the determination that the second travel route satisfies the third defined security criterion and/or the fourth defined security criterion. For example, navigational instructions can be displayed on a display of the device in response to the determination that the second travel route satisfies the third defined security criterion and/or the fourth defined security criterion. The navigational instructions can include, but is not limited to, voice-commands, written commands, pictures, maps, 3D imagery, graphical elements (e.g., arrows, etc.), a time counter, display of a distance to reach a next location, etc.

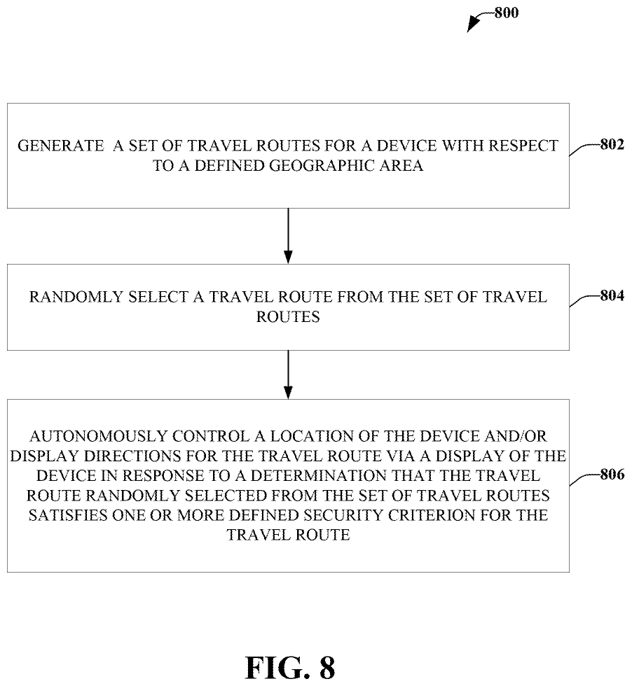

FIG. 8 illustrates an example, non-limiting embodiment of a method 800 to manage and/or generate a travel route for a device with respect to a geographic area. In an aspect, the method 800 can be associated with a surveillance system (e.g., a video surveillance system, a mobile surveillance system, a surveillance camera system, a mobile surveillance camera system, a patrol system, etc.). However, the method 800 can additionally or alternatively be associated with another type of system such as, for example, a navigation system, a global positioning system, a display system, an electronic device system, etc. The method 800 in FIG. 8 can be implemented using, for example, any of the systems, such as the system 200 (of FIG. 2), the system 300 (of FIG. 3), the system 400 (of FIG. 4), the system 500 (of FIG. 5), the system 510 (of FIG. 5B), the system 600 (of FIG. 6), etc., described herein below. The method 800 may include one or more operations, functions or actions as illustrated by one or more of blocks 802, 804 and/or 806. Beginning at block 802, a set of travel routes is generated for a device with respect to a defined geographic area. Block 802 may be followed by block 804. At block 804, a travel route from the set of travel routes is randomly selected. Block 804 may be followed by block 806. At block 806, a location of the device is autonomously controlled and/or directions for the travel route are displayed via a display of the device in response to a determination that the travel route randomly selected from the set of travel routes satisfies one or more defined security criterion for the travel route.

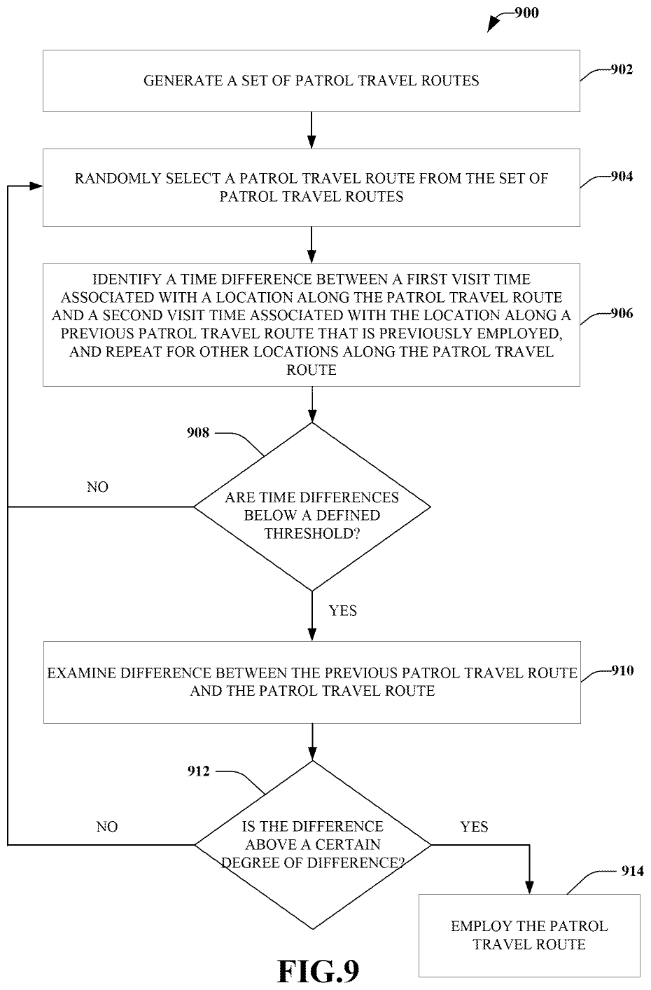

FIG. 9 illustrates an example, non-limiting embodiment of a method 900 to manage and/or generate a travel route for a device with respect to a geographic area. In an aspect, the method 900 can be associated with a surveillance system (e.g., a video surveillance system, a mobile surveillance system, a surveillance camera system, a mobile surveillance camera system, a patrol system, etc.). However, the method 900 can additionally or alternatively be associated with another type of system such as, for example, a navigation system, a global positioning system, a display system, an electronic device system, etc. The method 900 in FIG. 9 can be implemented using, for example, any of the systems, such as the system 200 (of FIG. 2), the system 300 (of FIG. 3), the system 400 (of FIG. 4), the system 500 (of FIG. 5), the system 510 (of FIG. 5B), the system 600 (of FIG. 6), etc., described herein below. The method 900 may include one or more operations, functions or actions as illustrated by one or more of blocks 902, 904, 906, 908, 910, 912 and/or 914.

Beginning at block 902, a set of patrol travel routes is generated. Block 902 may be followed by block 904. At block 904, a patrol travel route is randomly selected from the set of patrol travel routes. Block 904 may be followed by block 906. At block 906, a time difference between a first visit time associated with a location along the patrol travel route and a second visit time associated with the location along a previous patrol travel route that is previously employed is identified. For example, a interval of time for a device to travel to the location with respect to the patrol travel route and the previous patrol travel route can be estimated. Identification of a time difference is also repeated for other locations along the patrol travel route. Block 906 may be followed by block 908. At block 908, it is determined whether time differences are below a defined threshold. If no, method 900 may return to block 904. If yes, method 900 may proceed to block 910. At block 910, a difference between the previous patrol travel route and the patrol travel route is examined. Block 910 may be followed by block 912. At block 912, it is determined whether the difference is above a certain degree of difference. If no, method 900 may return to block 904. If yes, method 900 may proceed to block 914. At block 914, the patrol travel route is employed.

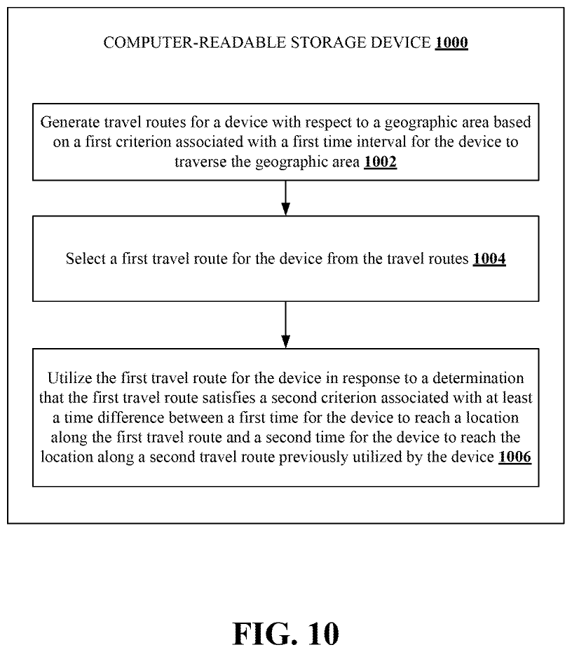

FIG. 10 illustrates a flow diagram of an example, non-limiting embodiment of a set of operations manage and/or generate a travel route for a device with respect to a geographic area in accordance with at least some aspects of the subject disclosure. The computer-readable storage device 1000 may include executable instructions that, in response to execution, cause a system including a processor to perform the set of operations. The set of operations may include one or more operations, functions or actions as is illustrated by one or more of operations 1002, 1004 and/or 1006. At operation 1002, travel routes is generated for a device with respect to a geographic area based on a first criterion associated with a first time interval for the device to traverse the geographic area. Operation 1002 may be followed by operation 1004. At operation 1004, a first travel route is selected for the device from the travel routes. For example, the first travel route can be selected for the device as a function of a random number (e.g., the travel route can be randomly selected). Operation 1004 may be followed by operation 1006. At operation 1006, the first travel route is utilized for the device in response to a determination that the travel route satisfies a second criterion associated with at least a time difference between a first time for the device to reach a location along the first travel route and a second time for the device to reach the location along a second travel route previously utilized by the device. In an embodiment, the travel route can additionally or alternatively be utilized for the device in response to a determination that the travel route satisfies the second criterion and a third criterion associated with a time difference between a third time for the device to reach another location along the first travel route and a fourth time for the device to reach the other location along the second travel route previously utilized by the device. In another embodiment, the travel route can additionally or alternatively be utilized for the device in response to a determination that a difference between the first travel route and the second travel route satisfies a fourth criterion. In another embodiment, a different travel route from the travel routes can be selected in response to a determination that the first travel route does not satisfy the second criterion, the third criterion and/or the fourth criterion.

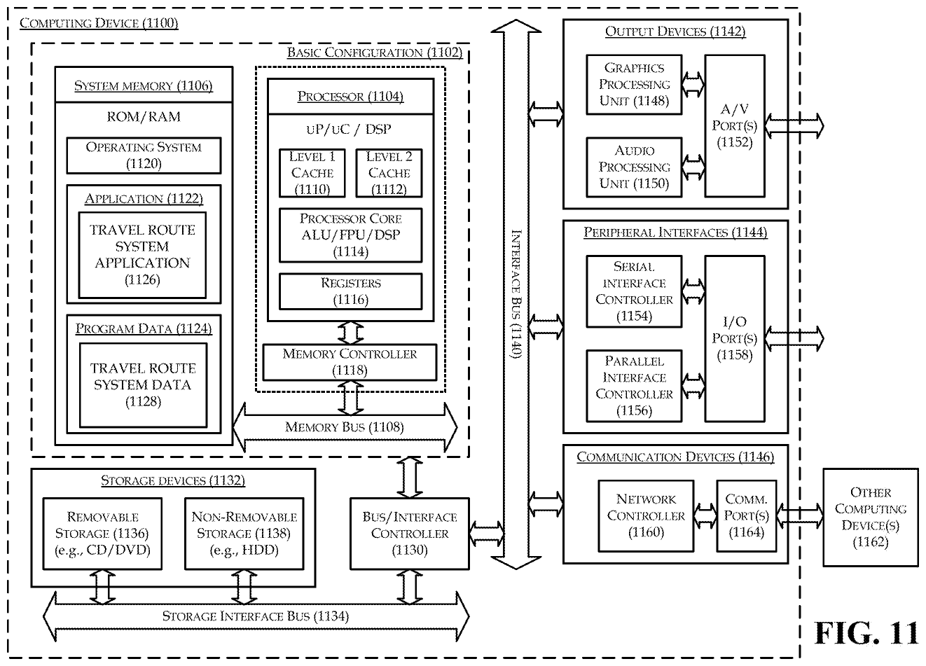

FIG. 11 illustrates an example block diagram of a computing device that is arranged to manage and/or generate a travel route for a device in accordance with one or more embodiments described herein. In a very basic configuration 1102, a computing device 1100 typically includes one or more processors 1104 and a system memory 1106. In some embodiments, the computing device 1100 can be or include the system 200, the system 300 or the system 400 (or components of the system 200, the system 300 or the system 400). For example, the computing device 1100 shown in FIG. 11 can be or include structure and/or functionality associated with the route generation component 208, the route selection component 210, the route analysis component 212, the control component 302, the navigation component 402 and/or any number of other components/modules/devices described herein. In some embodiments, system memory 1106 may be or include the system 200, the system 300 or the system 400 (or any components of the system 200, the system 300 or the system 400). A memory bus 1108 may be used for communicating between a processor 1104 and a system memory 1106.

Depending on the desired configuration, a processor 1104 may be of any type including but not limited to a microprocessor (μP), a microcontroller (μC), a digital signal processor (DSP), or any combination thereof. Processor 1104 may include one more levels of caching, such as a level one cache 1110 and a level two cache 1112, a processor core 1114, and registers 1116. An example processor core 1114 may include an arithmetic logic unit (ALU), a floating point unit (FPU), a DSP core, or any combination thereof. An example memory controller 1118 may also be used with processor 1104, or in some implementations a memory controller 1118 may be an internal part of processor 1104.

Depending on the desired configuration, system memory 1106 may be of any type including but not limited to volatile memory (such as RAM), non-volatile memory (such as ROM, flash memory, etc.) or any combination thereof. System memory 1106 may include an operating system 1120, one or more applications 1122 (e.g., a travel route system application 1126), and program data 1124 (e.g., travel route system data 1128). For example, the travel route system application 1126 can be or include one or more applications that can cause the computing device 1100 of FIG. 11 to manage and/or generate a travel route associated with the method 100, the system 200, the system 300, the system 400, the system 500, the system 510, the system 600, the method 700, the method 800, the method 900 or the computer-readable storage device 1000, as described herein. Travel route system data 1128 can be or include data (e.g., travel route data, geographic area data, location data, security criteria data, interval of time data, instructional data, threshold data, degree of difference data, machine learning data, etc.) employed by the method 100, the system 200, the system 300, the system 400, the system 500, the system 510, the system 600, the method 700, the method 800, the method 900 or the computer-readable storage device 1000 to manage and/or generate a travel route associated with the method 100, the system 200, the system 300, the system 400, the system 500, the system 510, the system 600, the method 700, the method 800, the method 900 or the computer-readable storage device 1000, as described herein. In some embodiments, computing device 1100 may be or be included in the system 200, the system 300 or the system 400 (or one or more components of the system 200, the system 300 or the system 400). In some embodiments, an application 1122 may be arranged to operate with program data 1124 on an operating system 1120 such that implementations for managing and/or generating a travel route may be performed as described herein. This described basic configuration 1102 is illustrated in FIG. 11 by those components within the inner dashed line.

Computing device 1100 may have additional features or functionality, and additional interfaces to facilitate communications between basic configuration 1102 and any required devices and interfaces. For example, a bus/interface controller 1130 may be used to facilitate communications between basic configuration 1102 and one or more data storage devices 1132 via a storage interface bus 1134. Data storage devices 1132 may be removable storage devices 1136, non-removable storage devices 1138, or a combination thereof. Examples of removable storage and non-removable storage devices include magnetic disk devices such as flexible disk drives and hard-disk drives (HDDs), optical disk drives such as compact disc (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

System memory 1106, removable storage devices 1136 and non-removable storage devices 1138 are examples of computer storage media. Computer storage media includes, but is not limited to, RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which may be used to store the desired information and which may be accessed by computing device 1100. Any such computer storage media may be part of computing device 1100.

Computing device 1100 may also include an interface bus 1140 for facilitating communication from various interface devices (e.g., output devices 1142, peripheral interfaces 1144, and communication devices 1146) to basic configuration 1102 via a bus/interface controller 1130. Example output devices 1142 include a graphics processing unit 1148 and an audio processing unit 1150, which may be configured to communicate to various external devices such as a display or speakers via one or more A/V ports 1152. Example peripheral interfaces 1144 include a serial interface controller 1154 or a parallel interface controller 1156, which may be configured to communicate with external devices such as input devices (e.g., keyboard, mouse, pen, voice input device, touch input device, etc.) or other peripheral devices (e.g., printer, scanner, etc.) via one or more I/O ports 1158. An example communication device 1146 includes a network controller 1160, which may be arranged to facilitate communications with one or more other computing devices 1162 over a network communication link via one or more communication ports 1164.

Computing device 1100 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 1100 may also be implemented as a personal computer including both laptop computer and non-laptop computer configurations.

A network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

The use of hardware or software may be generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples can be implemented, individually and/or collectively, by a wide range of hardware, software, firmware, or virtually any combination thereof. In one embodiment, several portions of the subject matter described herein can be implemented via Application Specific Integrated Circuits (ASICs), Field Programmable Gate Arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be possible in light of this disclosure. In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. A typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems. A typical data processing system can be implemented utilizing any suitable commercially available components, such as those typically found in data computing/communication and/or network computing/communication systems.

The herein described subject matter sometimes illustrates different components contained within, or connected with, different other components. Such depicted architectures are merely examples, and many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably coupleable,” to each other to achieve the desired functionality. Specific examples of operably coupleable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations can be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims can contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

The present disclosure is not to be limited in terms of the particular embodiments described in this application, which are intended as illustrations of various aspects. Many modifications and variations can be made without departing from its spirit and scope. Functionally equivalent methods and devices within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. This disclosure is not limited to particular methods, computer- readable storage devices, systems or apparatus disclosed, which can, of course, vary. The terminology used herein is for the purpose of describing particular embodiments only, and is not intended to be limiting.

1. A method, comprising:
generating, by a device comprising a processor, travel routes for the device with respect to a defined geographic area based on a total travel time for the device to traverse the defined geographic area;
determining that estimated time differences between visiting locations along a first travel route among the travel routes and corresponding visiting locations along a previous travel route previously employed by the device satisfy a defined security criterion;
selecting, by the device, the first travel route among the travel routes based on the determination; and
employing, by the device, the first travel route for the device.

2. The method of claim 1, further comprising:
randomly selecting a second travel route among the travel routes.

3. The method of claim 1, wherein the defined security criterion is a first defined security criterion, and wherein selecting the first travel route for the device comprises selecting the first travel route for the device in response to a determination that the first travel route satisfies the first defined security criterion and a second defined security criterion associated with a difference between the first travel route and the second travel route.

4. The method of claim 1, wherein the employing the first travel route for the device comprises controlling a geographic location of the device based on the first travel route in response to the determination that the first travel route satisfies the defined security criterion.

5. The method of claim 1, wherein the employing the first travel route for the device comprises displaying geographic destinations associated with the first travel route on a display of the device in response to the determination that the first travel route satisfies the defined security criterion.

6. The method of claim 1, further comprising:
selecting, by the device, a third travel route from the travel routes in response to a determination that the first travel route does not satisfy the defined security criterion.

7. A system, comprising:
a memory storing executable components; and
a processor, coupled to the memory, operable to execute or facilitate execution of one or more of the executable components, the executable components comprising:
a route generation component configured to generate a set of travel routes with respect to a defined geographic area based on a first defined criterion associated with a total travel time for an electronic device to travel through the defined geographic area;
a route selection component configured to select a first travel route from the set of travel routes based on a determination by a route analysis component; and
a route analysis component configured to:
determine that the first travel route satisfies a second defined criterion associated with a first estimated time difference between a first time for the electronic device to reach a location along the first travel route and a second time for the electronic device to reach the location along a second travel route previously provided to the electronic device; and
provide the first travel route to the electronic device.

8. The system of claim 7, wherein the route selection component is further configured to:
select a third travel route from the set of travel routes based on a random sampling technique.

9. The system of claim 7, wherein the route selection component is configured to select a third travel route from the set of travel routes in response to a determination that the first travel route does not satisfy the second defined criterion, and wherein the third travel route is different than the first travel route.

10. The system of claim 9, wherein the route analysis component is configured to provide the third travel route to the electronic device in response to a determination that the third travel route satisfies a third defined criterion associated with a second estimated time difference between a third time for the electronic device to reach the location along the third travel route and the second time for the electronic device to reach the location along the second travel route previously provided to the electronic device.

11. The system of claim 7, wherein the route analysis component is configured to provide the first travel route to the electronic device in response to a determination that the first travel route satisfies the second defined criterion and a third defined criterion associated with a difference between the first travel route and the second travel route previously provided to the electronic device.

12. The system of claim 11, wherein the route analysis component is configured to determine whether the first travel route satisfies the third defined criterion based on a Euclidean distance between the first travel route and the second travel route.

13. The system of claim 7, wherein the executable components further comprise a control component configured to control a geographic location of the electronic device based on the first travel route in response to the determination that the first travel route satisfies the second defined criterion.

14. The system of claim 7, wherein the executable components further comprise a navigation component configured to display a set of navigation instructions associated with the first travel route on a display of the electronic device in response to the determination that the first travel route satisfies the second defined criterion.

15. A computer-readable storage device comprising executable instructions that, in response to execution, cause a system comprising a processor to perform operations, comprising:
generating travel routes for a device with respect to a geographic area based on a first criterion associated with a time interval for the device to traverse the geographic area;
determining that a first travel route satisfies a second criterion associated with a time difference between a first time for the device to reach a location along the first travel route and a second time for the device to reach the location along a second travel route previously utilized by the device;
selecting the first travel route for the device from the travel routes in response to the determination; and
utilizing the first travel route for the device.

16. The computer-readable storage device of claim 15, wherein the operations further comprise selecting a third travel route from the travel routes as a function of a random number.

17. The computer-readable storage device of claim 15, wherein the selecting the first travel route for the device comprises selecting the first travel route for the device in response to a determination that the first travel route satisfies the second criterion and a third criterion associated with a difference between the first travel route and the second travel route previously utilized by the device.

18. The computer-readable storage device of claim 15, wherein the utilizing the first travel route for the device comprises autonomously controlling a location of the device based on the first travel route.

19. The computer-readable storage device of claim 15, wherein the utilizing the first travel route for the device comprises displaying directions for the first travel route via a display of the device.

20. The computer-readable storage device of claim 15, wherein the operations further comprise:
selecting a third travel route from the travel routes in response to a determination that the first travel route does not satisfy the second criterion.

21. A method for travel route management, the method comprising:
generating a plurality of travel routes for a device to travel through a defined geographic area based on a total travel time for the device to traverse the defined geographic area, wherein each of the plurality of travel routes includes two or more visiting locations;
selecting a first travel route among the plurality of travel routes to be employed by the device as initial travel route to traverse the defined geographic area; and
selecting a second travel route among the remaining ones of the plurality of travel routes to be employed by the device to traverse the defined geographic area based on one or more of: a random selection among the remaining ones of the plurality of travel routes, a randomization of visiting locations along the remaining ones of the plurality of travel routes, or an adjustment of travel time between two selected visiting locations along the remaining ones of the plurality of travel routes.

22. The method of claim 21, wherein selecting the second travel route based on the random selection among the remaining ones of the plurality of travel routes comprises:
excluding the first travel route from the remaining ones of the plurality of travel routes.

23. The method of claim 21, wherein selecting the second travel route based on the randomization of the visiting locations along the remaining ones of the plurality of travel routes comprises:
selecting the second travel route to include at least one visiting location that is not included in the first travel route.

24. The method of claim 21, wherein selecting the second travel route based on the randomization of the visiting locations along the remaining ones of the plurality of travel routes comprises:
selecting the second travel route to include an order of the two or more visiting locations that is different from an order of the two or more visiting locations in the first travel route.
